(19) United States
(12) Patent Application Publication
(10) Pub. No.: US 2014/0035921 A1
(43) Pub. Date: Feb. 6, 2014

(54) ANALYSIS AND VISUALIZATION OF PASSENGER MOVEMENT IN A TRANSPORTATION SYSTEM

(71) Applicant: Andrew S. Yeh, Portland, OR (US)

(72) Inventor: Andrew S. Yeh, Portland, OR (US)

(73) Assignee: XEROX CORPORATION, Norwalk, CT (US)

(21) Appl. No.: 13/563,022

(22) Filed: Jul. 31, 2012

(51) Int. Cl. G06T 11/20

(52) U.S. Cl. 345/440

(57) ABSTRACT

A method and a device for analyzing and presenting origin-destination (OD) data for a transportation system are disclosed. The method includes receiving operational information comprising information collected during and related to operation of at least one vehicle in the transportation system. An OD matrix is determined matrix based upon the operational information and a results set is produce based upon the OD matrix. At least a portion of the results set is output as a graphical representation. The device includes at least a processing device and computer readable medium containing a set of instructions configured to cause the device to perform the method.

### BACKGROUND

The present disclosure relates to analyzing and providing a graphical representation of data for a transportation system, such as a public bus, train or plane system. More specifically, the present disclosure relates to analyzing and providing a graphical representation of origin-destination data for a transportation system.

Many service providers monitor and analyze analytics related to the services they provide. For example, computer aided dispatch/automated vehicle location (CAD/AVL) is a system in which public transportation vehicle positions are determined through a global positioning system (GPS) and transmitted to a central server located at a transit agency's operations center and stored in a database for later use. The CAD/AVL system also typically includes two-way radio communication by which a transit system operator can communicate with vehicle drivers. The CAD/AVL system may further log and transmit incident information including an event identifier (ID) and a time stamp related to various events that occur during operation of the vehicle. For example, for a public bus system, logged incidents can include door opening and closing, driver logging on or off, wheel chair lift usage, bike rack usage, current bus condition, passenger boarding and alighting, and other similar events. Some incidents are automatically logged by the system as they are received from vehicle on-board diagnostic systems or other data collection devices, while others are entered into the system manually by the operator of the vehicle.

For a typical public transportation company, service reliability is defined as variability of service attributes. Problems with reliability are ascribed to inherent variability in the system, especially demand for transit, operator performance, traffic, weather, road construction, crashes, and other unavoidable or unforeseen events. As transportation providers cannot control all aspects of operation owing to these random and unpredictable disturbances, they must adjust to the disturbances to maximize reliability. Several components that determine reliable service are schedule adherence, maintenance of uniform headways (e.g., the time between vehicles arriving in a transportation system), maintaining balanced passenger loads, and overall trip times.

By using a CAD/AVL system, transit operators can easily obtain current and historical operation information related to a vehicle or a fleet of vehicles. However, the information generally shows performance of the transportation system over a period of time and includes a large amount of data that is not easily understood by a human operator or manager of the transportation system.

### SUMMARY

In one general respect, the embodiments disclose a method of analyzing and presenting origin-destination (OD) data for a transportation system. The method includes receiving, by a processing device, operational information comprising information collected during and related to operation of at least one vehicle in the transportation system; determining, by the processing device, an OD matrix based upon the operational information; producing, by the processing device, a results set based upon the OD matrix; and outputting, by the processing device, at least a portion of the results set as a graphical representation.

In another general respect, the embodiments disclose a device for analyzing and presenting origin-destination (OD) data for a transportation system. The device includes a processor and a computer readable medium operably connected to the processor, the computer readable medium containing a set of instructions configured to instruct the processor to receive operational information comprising information collected during and related to operation of at least one vehicle in the transportation system, determine an OD matrix based upon the operational information, produce a results set based upon the OD matrix, and output at least a portion of the results set as a graphical representation.

### BRIEF DESCRIPTION OF THE DRAWINGS

FIG. 1 depicts a sample flow diagram of an iterative proportional fitting algorithm according to an embodiment.

FIGS. 1b-1e depict an origin-destination matrix as determined by an iterative proportional fitting algorithm according to an embodiment.

FIG. 2 depicts a geographic map showing a portion of a transportation system's coverage including stops and analysis zones according to an embodiment.

FIGS. 3a and 3b depict a user interface for selecting a transportation analysis zone and receiving information related to that zone according to an embodiment.

FIG. 4 depicts a user interface showing a choropleth graph according to an embodiment.

FIG. 5 depicts a sample flow chart for collecting and displaying various data related to the operation of a transportation vehicle according to an embodiment.

FIG. 6 depicts a sample flow diagram of a method for analyzing and visualizing origin-destination information according to an embodiment.

FIG. 7 depicts various embodiments of a computing device for implementing the various methods and processes described herein.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, a “computing device” refers to a device that processes data in order to perform one or more functions. A computing device may include any processor-based device such as, for example, a server, a personal computer, a personal digital assistant, a web-enabled phone, a smart terminal, a dumb terminal and/or other electronic device capable of communicating in a networked environment. A computing device may interpret and execute instructions.

A “trip” represents an instance of travel from an origin point i to a destination point j. A trip may be represented as Tᵢⱼ.

An “origin-destination matrix” or “OD matrix” refers to a table showing a distribution of trips from various origins to various destinations. Each cell in the matrix displays the number of trips going from a specific origin to a specific destination and may be scaled by time, total trips, or another appropriate factor.

An “iterative proportional fitting” (IPF) procedure or algorithm refers to a maximum likelihood technique developed to estimate cell probabilities in a matrix given the constraints of known marginal row and column totals.

A “choropleth map” refers to a map in which areas are shaded or patterned in proportion to a measurement of a statistical variable being displayed on the map.

The present disclosure is directed to a method and system for analyzing data from a service provider, such as a public transportation system service provider, and providing a graphical representation of the analyzed data. For example, public transportation companies monitor passenger related analytics for a transportation system. Generally, the analytics reflect average performance of the transit system, variation of the performance over time, and a general distribution of performance over time. For a public transportation system, low quality of service can result in decreased ridership, higher costs and imbalanced passenger loads. From a passenger perspective, reliable service requires origination and destination points that are easily accessible, predictable arrival times at a transit stop, short running times on a transit vehicle, balanced passenger loads, and low variability of running time. Poor quality of service can result in passengers potentially choosing another transportation option, thereby hurting the public transportation company potential income.

In an embodiment, a transportation system may use a computer aided dispatch/automated vehicle location (CAD/AVL) system to monitor and store data that is used to determine historical passenger statistics for a particular route (e.g., time and location of a stop, dwell time, and other related statistics). Additionally, each vehicle in the public transportation system may include an automated passenger count (APC) device for measuring the number of passengers that board and alight at each stop in the system. Based upon this collected passenger information, the present disclosure further provides creating an OD matrix for a transportation system based upon the historic data and providing a graphical representation for the historical data such that passenger boarding and alighting information may be quickly determined.

Analysis and visualization of the data may be interactive for one or more users. Thus, the process used for analysis and visualization may be optimized for fast performance, and the data may be retrieved from a real-time database.

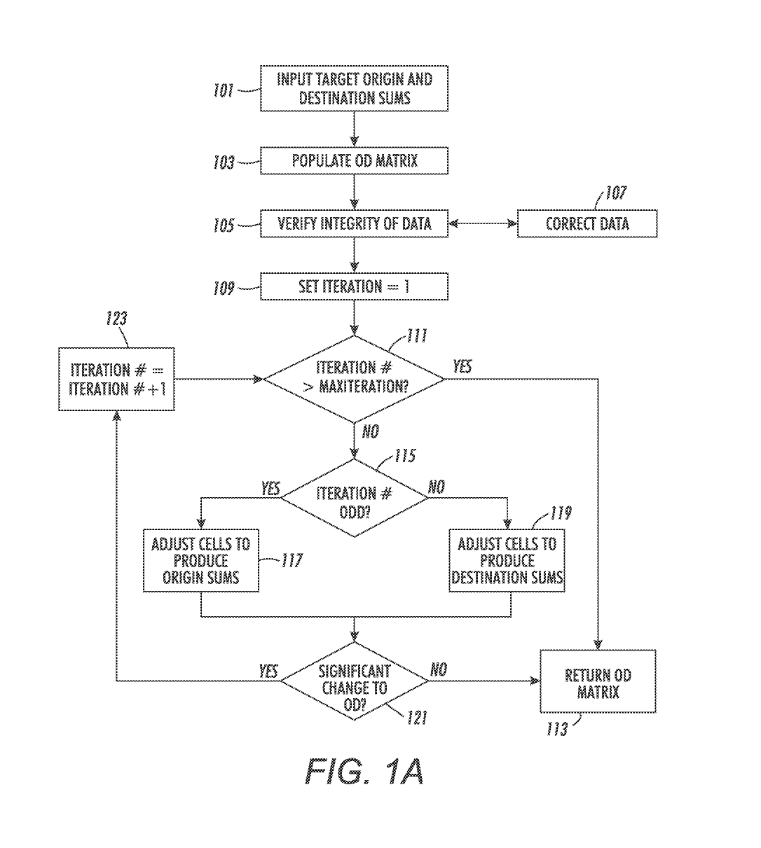

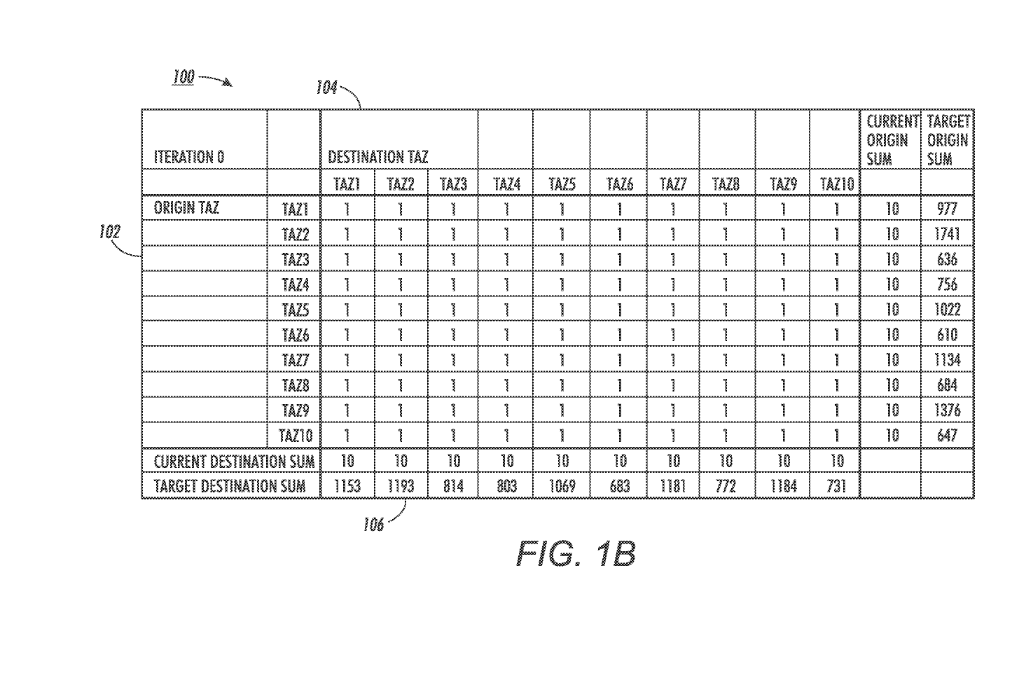

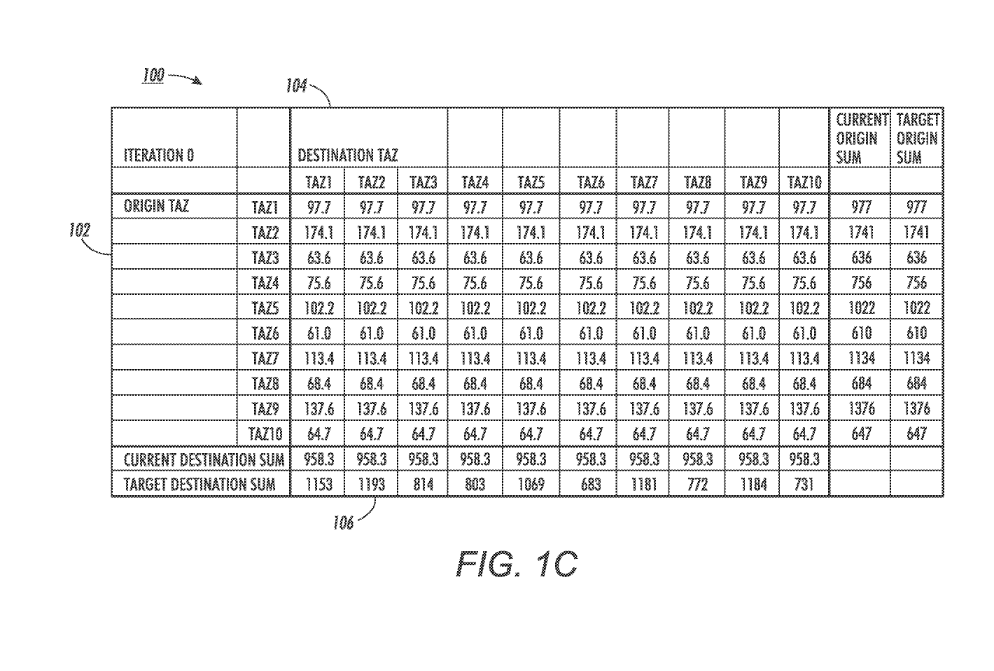

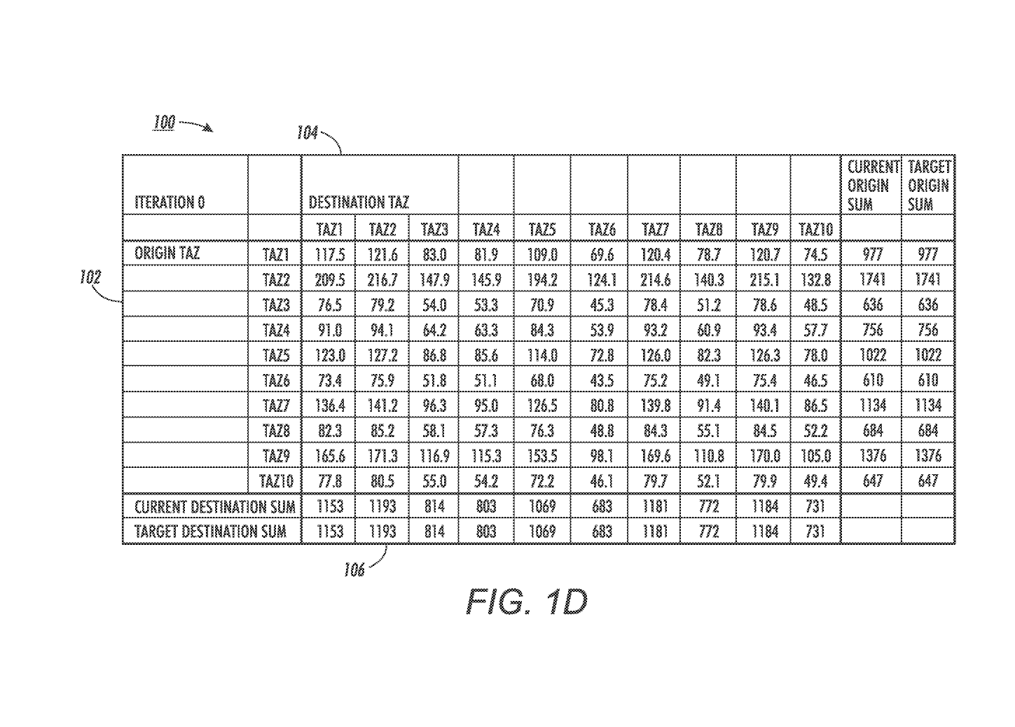

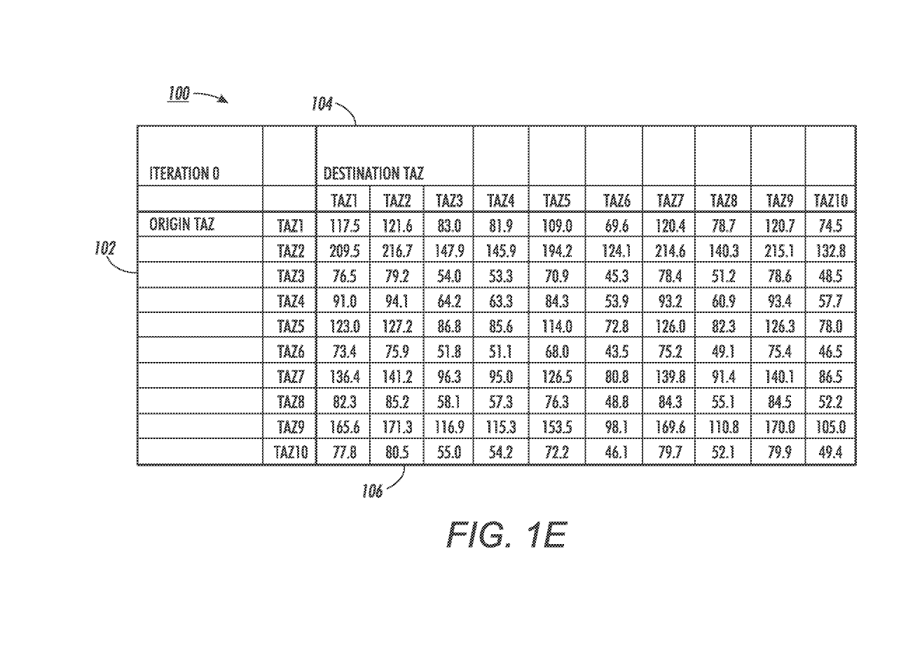

For each passenger using the transportation system, a trip may be assigned where the trip includes the stop the passenger boards a vehicle and a stop where the passenger alights the vehicle. A collection of trips for a group of passengers may be illustrated in an OD matrix such as OD matrix 100 as shown in FIGS. 1b-1e.

For a transportation system with S stops, the OD matrix would have 2*S constraints and S² cells. It should be noted that in a medium sized city, the number of stops for a transportation system may be several thousand (e.g., 7,000). As such, an OD matrix for that system would have 49,000,000 cells. The OD matrix may be simplified by aggregating individual stops into transportation analysis zones (TAZs). For example, the 7,000 individual stops in the above system may be aggregated into 350 zones, each zone having an average of 20 stops. This results in an OD matrix having 122,500 cells. A processing device may be able to populate and analyze a matrix of that size much quicker than a matrix having 49,000,000 cells.

Referring again to FIGS. 1b-1e, the vertical axis 102 of each matrix may list the origin TAZs for a particular transportation system. Similarly, the horizontal axis 104 of each matrix may list the destination TAZs.

Based upon the information collected from the APC system, a transportation system operator may know the total number of people boarding in each origin TAZ (i.e., the sum of each row in the OD matrices 100) as well as the total number of people of people alighting in each destination TAZ (i.e., the sum of each column in the OD matrices 100). Additional information such as information collected in a census, household survey, or rider survey may also be available, indicating the common trips of a surveyed rider. Additional information such as information collected from uniquely identifiable fare cards may also be available, indicating passenger boarding information and possibly passenger alighting information. However, trip information for individual passengers from each origin TAZ to each destination TAZ is not universally known. Thus, there may be a high number of possible solutions for the OD matrix consistent with the information at hand, or none at all, and a challenge is to find an optimal solution in a short amount of time, preferably suitable for interaction while the data is still being collected.

Historically, IPF techniques have been used for census applications by combining data from different data sources to produce results that are likely to be accurate to the actual results when the actual results are impossible or impractical to obtain. A typical IPF includes one or more assumptions about each cell and determines the values of the cells of an OD matrix such that the values: 1) approximate a Poisson or multinomial distribution; 2) approximate the row and column sums from the data; and 3) optionally approximate a previously determined OD matrix.

FIG. 1a illustrates a sample flow diagram for an IPF procedure. The target origin and destination sums may be input 101 into the OD matrix. The cells of the matrix may be populated 103 with inputted initial values or with default values. For example, as shown in FIG. 1b, the OD matrix 100 includes the origin and destination sums as well as initial values for the cells 106.

The integrity of the input data may be verified 105 and, if the data is determine to have any errors, the data may be corrected 107. A counter Iteration# may initially be set 109 to 1, and a comparison 111 of the Iteration# value and a value of MaxIteration, or the maximum number of iterations to perform in the IPF procedure, is performed. If, during the comparison 111, the value of Iteration# is greater than the value of MaxIteration, the IPF procedure is completed and the finished OD matrix may be returned 113. Otherwise, the IPF procedure advances to determine 115 where it is determine whether the Iteration# value is odd. If the value for Iteration# is odd, the cells in the OD matrix are adjusted 117 to produce the target origin sums. For example, the updated values for ODᵢⱼ may equal OD*(target sum for origin i)/(sum for destination j for ODᵢⱼ). FIG. 1c illustrates an example OD matrix 100 where the cells have been adjusted 117 to produce the correct origin sums, but the destination sums may deviate from the target values.

Conversely, if the value for Iteration# is not odd, the cells in the OD matrix are adjusted 119 to produce the target destination sums. For example, the updated values for ODᵢⱼ may equal ODᵢⱼ*(target sum for destination j)/(sum for origin i for ODᵢⱼ). FIG. 1d illustrates an example OD matrix 100 where the cells have been adjusted 119 to produce the correct destination sums, but the origin sums may deviate from the target values.

After adjusting 117, 119 the cells, it is determined 121 whether there was significant change to the OD matrix. To determine 121 if a significant change have occurred, the total changed value in the OD matrix may be compared to a threshold value. If the total changed value does not exceed the threshold, the IPF procedure may complete and the OD matrix may be returned 113. Otherwise, if there is significant change to the OD matrix, the Iteration# value may be incremented by 1 and a portion of the process as shown in FIG. 1a may be repeated.

With each repetition of the IPF procedure, the total changes to the OD matrix become smaller and smaller until the OD matrix is within an acceptable error level. To reach an acceptable error level, both the MaxIteration value and the threshold value may be selected accordingly.

OD matrix 100 as shown in FIG. 1e represents a final OD matrix. For example, there are no changes between the values in FIG. 1e and the values in FIG. 1d and, thus, the determination 121 would result in a zero change value, thus completing the IPF procedure and returning 113 the OD matrix.

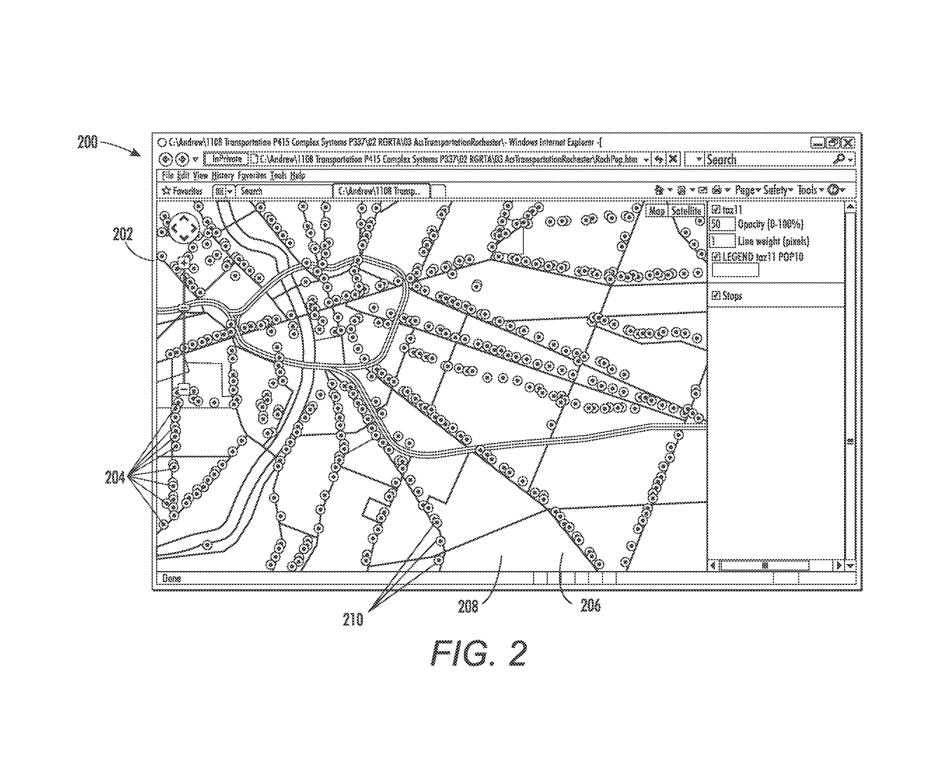

FIG. 2 illustrates an example of a user interface (UI) 200 for viewing the OD data related to and contained within an OD matrix such as OD matrix 100. As shown in the UI 200, a map 202 may be shown, defining a plurality of stops 204 within a transportation system. A grid of lines may be overlaid on the map 202, defining a plurality of TAZs. For example, line 206 may provide an eastern boundary of TAZ 208, and TAZ 208 may include multiple stops 210.

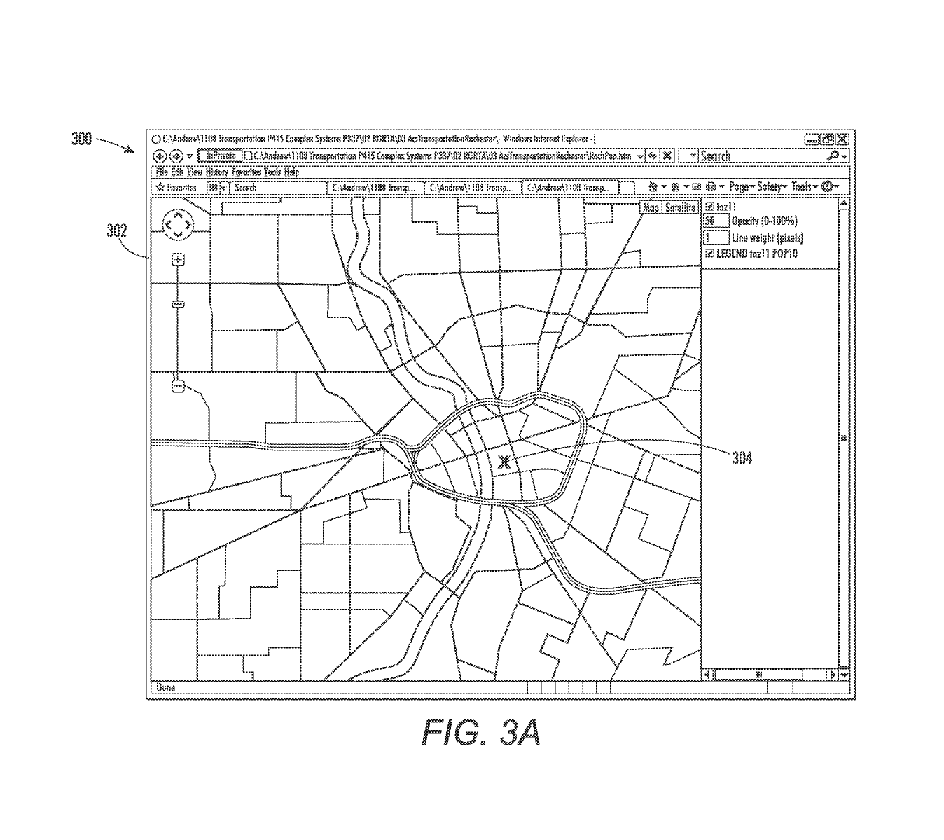

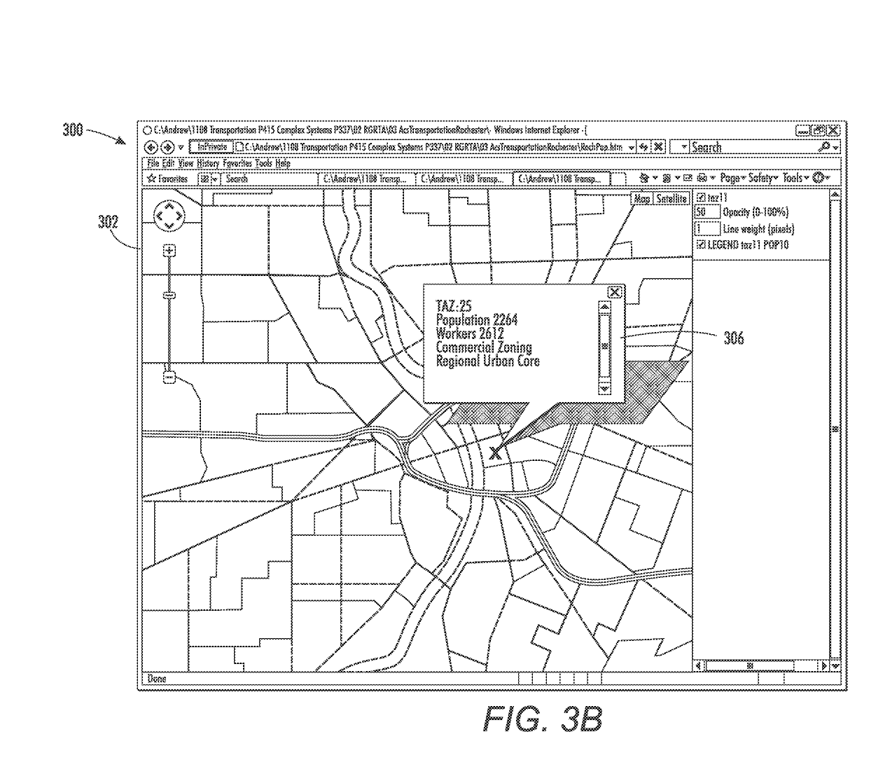

FIG. 3a illustrates a similar UI 300 showing a map 302. The map includes a user-selectable set of TAZs, each TAZ having a set of associated data pulled from an OD matrix and/or an associated database. For example, as shown in FIG. 3b, the user-selected TAZ 304 includes a set of overlaid information 306 that has been merged with the map data. This information 306 may include the name of the TAZ, the population of the TAZ, the number of employee people in the TAZ, a number of passengers boarding daily in that TAZ, number of passengers alighting daily in that TAZ, and other related information. It should be noted that the information 306 as shown in and discussed with regard to FIG. 3 is by way of example only.

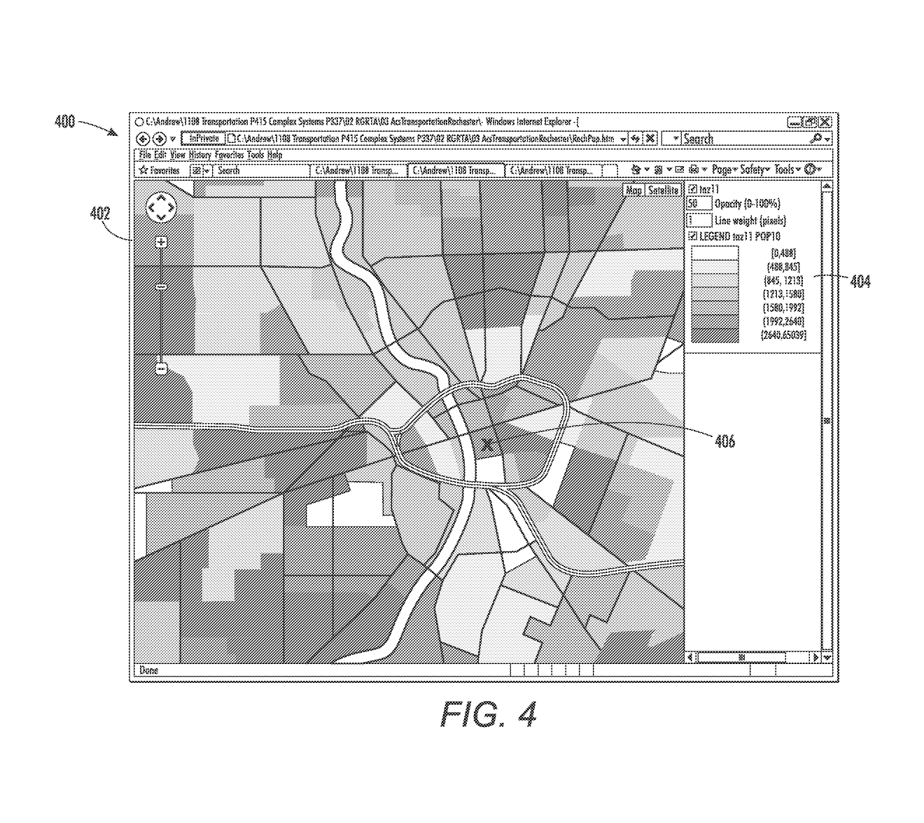

FIG. 4 illustrates a UI 400 showing a choropleth map 402. A user may select an individual TAZ on the map 402, for example TAZ 406, and the coloration or patterns displayed on the map may change to reflect information specific to that TAZ. The UI 400 may include a key 404 for assisting a user in interpreting the information shown in the MAP 402. For example, a user may set the UI 400 to show which how people who board a bus in a particular TAZ alight the bus in each of the other TAZs. The user may select a TAZ, such as TAZ 406, and the map may update to reflect the alighting information. This mapping technique presents a large amount of data (e.g., the data contained within an OD matrix) in a human understandable fashion.

The information as shown in FIG. 4 may be used by a transportation agency to update specific routes either in response to historic information or based upon real-time statistics. For example, if the map 402 indicates a high level of passengers boarding in TAZ 20 and alighting in TAZ 42, the transportation agency may send additional vehicles to transport passengers from TAZ 20 to TAZ 42, thereby resulting in a uniform passenger volume on each vehicle and maintaining a high level of quality of service.

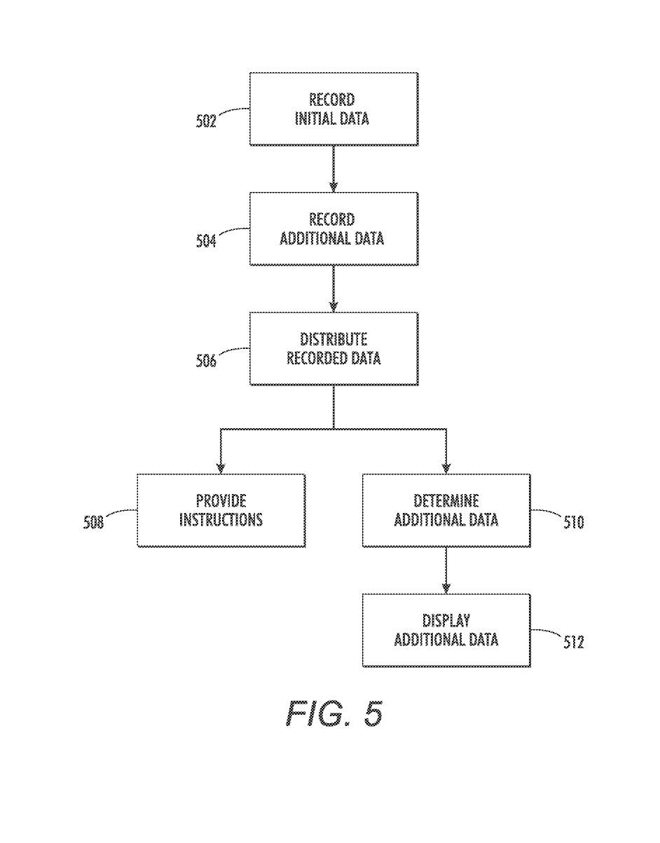

FIG. 5 illustrates a sample flow chart for collecting and displaying various data related to the operation of a transportation vehicle such as a bus. Upon starting operation of the transportation vehicle, a set of initial data may be recorded 502. For example, if the transportation vehicle is a bus, the operator of the bus may enter their driver identification, route number, bus number, and other related information into the CAD/AVL system. The CAD/AVL system may record 502 this data, along with other data such as a timestamp and the geographic location of the bus.

During operation of the bus, the CAD/AVL system and the APC system may record 504 additional data such as an arrival time at each stop, duration of time spent at each stop, number of passengers boarding at each stop, number of passengers alighting at each stop, departure time from each stop, travel time between each stop, average travel speed, maximum travel speed, number of times a wheelchair ramp is used, and other related information. Additionally, the operator of the vehicle may manually enter additional information into the CAD/AVL system to be recorded 504. For example, each time a bike rack is accessed the driver may record 504 this information into the CAD/AVL system. It should be noted that in various transportation system there may be automatic sensors for detecting events such as bike rack and wheel chair ramp usage.

Depending on the capabilities of the CAD/AVL and APC systems, the system may distribute 506 the data to a central server according to a set schedule. For example, depending on the network connection of the CAD/AVL and APC systems, the system may upload the data each time a new entry is recorded 502, 504. Alternatively, the information may be distributed 506 from the CAD/AVL and APC systems at the end of a route or the end of an operator's shift.

Based upon the distributed 506 data, the server or a similar processing device at the transportation agency may perform various additional functions. For example, if the data indicates a particular vehicle is running ahead of schedule, instructions may be provided 508 to the operator of that vehicle to slow down or to spend additional time at the next stop. Additionally, based upon geographic information received from a vehicle, the server may determine that the vehicle is approaching heavy traffic or a crash, and provide 508 the operator of the vehicle instructions to take an alternate route.

Similarly, based upon the distributed 506 information, the transportation agency server may determine 510 additional data such as current origin-destination data. For example, the server may determine 510 that a particular stop or zone of stops has a high number of people boarding for a particular destination stop or zone of stops. The transportation may opt to act accordingly to handle this large number of people and maintain balanced passenger loads. For example, the transportation agency may opt to add an express bus that picks up only in the zones where a high number of people are boarding and stops only in the zones where the most people intend to depart the bus. The server may transmit instructions to display 512 information related to the newly added bus at an electronic sign or display at each of those stops where high numbers of passengers are boarding, letting the passengers know that a new bus is coming. Similarly, information may be pushed to passengers via a mobile application or as a text-based data message.

For example, a sporting event may be taking place downtown and large numbers of people are coming from the suburbs via public transportation for the event. The transportation agency may view the origin departure data in real time and may dispatch additional buses to handle the increased crowds. Similarly, historic data may be used to anticipate high crowds and their public transportation needs. For example, every night there is a sporting event the transportation agency may increase the number of vehicles running on the historically busiest routes.

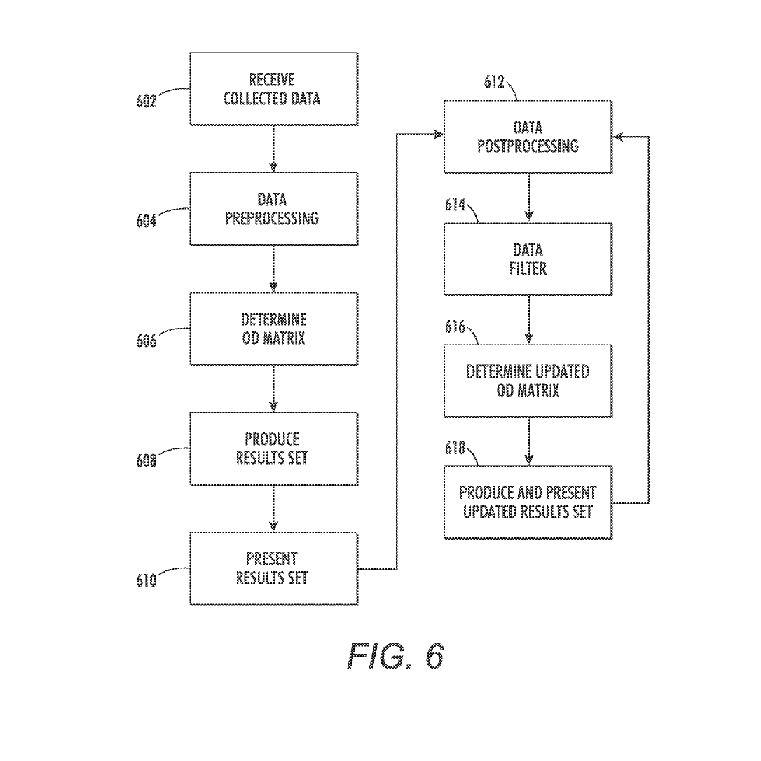

FIG. 6 illustrates a sample flow diagram of a method for analyzing and visualizing origin-destination information. A processing device such as a server or other computing device may receive 602 collected data from one or more vehicles in a transportation system. For example, at least a portion of the process as shown in FIG. 5 may be used to provide the collected information.

In order to reduce potential error, the received collected data may be preprocessed 604. The preprocessing 604 may remove any data that is incomplete, unlikely, or unknown using heuristic or statistical data filtering techniques. An OD matrix may be determined 606 based upon the preprocessed information and IPF techniques, as discussed above, or other optimization techniques. For example, the OD matrix may be determined 606 based upon the number of passengers boarding at each stop (as collected by the APC system) and the number of passengers alighting at each stop (as collected by the APC system). Alternatively, the OD matrix may be determined 606 based upon the number of passengers boarding at each stop, the number of passengers alighting at each stop, and an initial estimate of an OD matrix. The initial estimate OD matrix may be based upon historical data or upon census or survey data collected from passengers on the transportation system.

A results set may be produced 608 based upon the determined OD matrix. For example, the results set may include map information merged with at least a portion of the information contained within the OD matrix to produce an interactive map such as map 302 as shown in FIG. 3b. Similarly, a results set may be produced 608 that includes a choropleth map such as map 402 shown in FIG. 4.

The results set may be presented 610 to a user. For example, an operator associated with a transportation agency may access at least a portion of the results to determine current origin-destination trends for the transportation system. The operator may adjust resources accordingly based upon the information. For example, the operator may dispatch additional vehicles to maintain safe and comfortable vehicle loads.

A transportation agency may also use the information to view origin-destination trends over a longer period of time. Based upon this longer analysis, the transportation agency may adjust schedules, revise stops or modify routes.

Additionally, the user may be able to perform 612 post-processing on the produced results to calculate and visualize a subset of data. For example, the user may be able to filter 614 the data to show route and/or link specific metrics. Based upon the post-processing 612 and filtering 614, an updated OD matrix may be determined 616. An updated results set may be produced and presented 618 including an updated graphical representation showing specific link utilization, or the number of passengers who ride a specific bus route or a specific portion of a bus route.

Similarly, a user may be able to filter 614 the data to shown system utilization for a specific period of time. For example, the user may filter 614 the date to show usage data for peak time periods (e.g., during rush hours or other high volume times), non-peak time periods (e.g., low volume times), or user-defined time periods such as weekends, weekdays, morning/evening rush hours, individual seasons, and other time periods. The system may produce and present 618 an updated results set showing a graphical representation directed to the user-selected subset of data. For example, the system may produce and present 618 an updated results set showing the peak time period usage for a user-selected zone of interest. This information may assist in planning future schedules for the transportation system.

Additionally, a user may want to display additional information collected by the CAD/AVL system such as vehicle feature utilization including, for example, wheelchair lift usage and bus mounted bike rack usage. The user may filter 614 the data to show the additional information as collected by the CAD/AVL system and produce and present 618 an updated results set showing the filtered data. For example, the user may view how often passengers boarding in a specific TAZ use a wheelchair lift and to which destination TAZ those passengers are traveling. Reviewing vehicle feature usage may allow a transportation agency to better assign vehicles equipped with wheelchair lifts to routes with a higher usage. Similarly, bus mounted bicycle rack usage may be monitored and analyzed.

It should be noted that the combination of post-processing 612, filtering 614, determining 616 an updated OD matrix, and producing and presenting 618 an updated results set are merely shown as examples of post-processing. Additional post-processing may be performed on the data, including report production based upon the OD matrix data, changes to stops which are included in which TAZs, changes to individual map views including adding or removing text fields from the maps, route evaluation based upon passenger usage of the route as determined from the OD matrix data, and other related post-processing functions. These post-processing functions provide additional functionality and usefulness of the analysis and visualization system described herein, thereby allowing a user or a transportation agency to quickly determine additional operational information that may be used to increase overall transportation system efficiency while reducing overall transportation system costs.

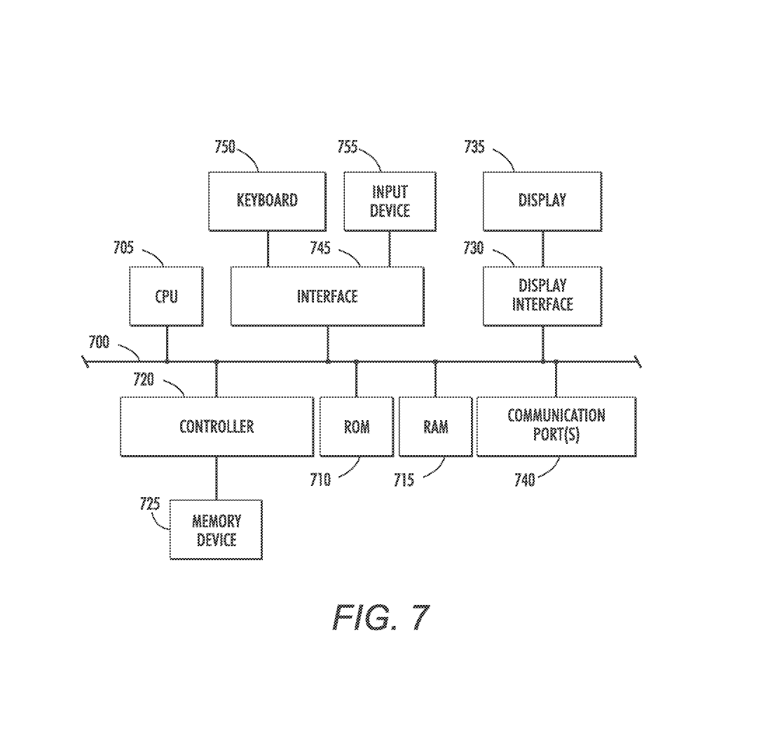

The OD matrix calculations and derivations, and visualization techniques as described above may be performed and implemented by one or more computing devices located at one or more locations, such as an operations center (e.g., a central operations center for a public transportation provider). FIG. 7 depicts a block diagram of various hardware that may be used to contain or implement the various computer processes and systems as discussed above. An electrical bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is a processing device, computing device or processor as such terms are used within this disclosure. Read only memory (ROM) 710 and random access memory (RAM) 715 constitute examples of memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices. Additionally, the memory devices 725 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 710 and/or the RAM 715. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

A display interface 730 may permit information to be displayed on the display 735 in audio, visual, graphic or alphanumeric format. For example, the UI discussed in the context of FIGS. 2-4 may be embodied in the display 735. Communication with external devices may occur using various communication ports 740. A communication port 740 may be attached to a communications network, such as the Internet or a local area network.

The hardware may also include an interface 745 which allows for receipt of data from input devices such as a keyboard 750 or other input device 755 such as a mouse, a joystick, a touch screen, a remote control, a pointing device, a video input device and/or an audio input device.

It should be noted that a public transportation system is described above by way of example only. The processes, systems and methods as taught herein may be applied to any environment where performance based metrics and information are collected for later analysis, and provided services may be altered accordingly based upon the collected information to improve reliability.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of analyzing and presenting origin-destination (OD) data for a transportation system, the method comprising:
receiving, by a processing device, operational information comprising information collected during and related to operation of at least one vehicle in the transportation system;
determining, by the processing device, an OD matrix based upon the operational information;
producing, by the processing device, a results set based upon the OD matrix; and
outputting, by the processing device, at least a portion of the results set as a graphical representation.

2. The method of claim 1, wherein producing the results set comprises merging, by the processing device, the OD matrix with map information to produce the graphical representation showing at least a portion of the operational information.

3. The method of claim 2, wherein the graphical representation includes at least one user-selectable area that, in response to a user selection, displays additional information.

4. The method of claim 2, wherein the graphical representation comprises a choropleth map.

5. The method of claim 1, further comprising preprocessing, by the processing device, the collected information to reduce potential errors.

6. The method of claim 1, wherein the information comprises at least boarding and alighting information for the transportation system.

7. The method of claim 6, wherein the determining the OD matrix comprises applying an iterative proportional fitting technique to at least a portion of the operational data.

8. The method of claim 6, wherein the information further comprises information collected in a census, household survey, or rider survey.

9. The method of claim 8, wherein the determining the OD matrix comprises applying an iterative proportional fitting technique to at least a portion of the operational data.

10. The method of claim 1, further comprising performing, by the processing device in response to a request by a user, post-processing on the results set to produce modified results set.

11. The method of claim 10, further comprising outputting, by the processing device, a modified graphical representation showing at least a portion of the modified results set.

12. The method of claim 10, wherein the modified results set comprises at least one of a user-selected zone of interest, route of interest, link utilization information, peak system utilization, non-peak system utilization, system utilization over a specific user-defined time period, and vehicle feature utilization.

13. A device for analyzing and presenting origin-destination (OD) data for a transportation system, the device comprising:
a processor; and
a computer readable medium operably connected to the processor, the computer readable medium containing a set of instructions configured to instruct the processor to perform the following:
receive operational information comprising information collected during and related to operation of at least one vehicle in the transportation system,
determine an OD matrix based upon the operational information,
produce a results set based upon the OD matrix, and
output at least a portion of the results set as a graphical representation.

14. The device of claim 13, wherein the instructions for instructing the processor to produce the results set comprise instructions configured to instruct the processor to merge the OD matrix with map information to produce the graphical representation showing at least a portion of the operational information.

15. The device of claim 14, wherein the graphical representation includes at least one user-selectable area that, in response to a user selection, displays additional information.

16. The device of claim 13, further comprising instructions configured to instruct the processor to preprocess the collected information to reduce potential errors.

17. The device of claim 13, wherein the information comprises at least boarding and alighting information for the transportation system.

18. The device of claim 17, wherein the instructions configured to instruct the processor to determine the OD matrix comprise instructions configured to instruct the processor to apply an iterative proportional fitting technique to at least a portion of the operational data.

19. The device of claim 17, wherein the information further comprises information collected in a census, household survey, or rider survey.

20. The device of claim 19, wherein the instructions configured to instruct the processor to determine the OD matrix comprise instructions configured to instruct the processor to apply an iterative proportional fitting technique to at least a portion of the operational data.
